(19) United States
(12) Patent Application Publication
(10) Pub. No.: US 2015/0046232 A1
(43) Pub. Date: Feb. 12, 2015

(54) SYSTEMS AND METHODS FOR ORDER ATTRIBUTE TRACKING

(71) Applicant: Level 3 Communications, LLC, Broomfield, CO (US)

(72) Inventors: Cecil Sunder, Broomfield, CO (US); Ophir Rahmani, Arvada, CO (US); Tara Risser, Golden, CO (US); Derick K. Zines, Denver, CO (US)

(73) Assignee: Level 3 Communications, LLC, Broomfield, CO (US)

(21) Appl. No.: 14/456,846

(22) Filed: Aug. 11, 2014

Related U.S. Application Data
(60) Provisional application No. 61/864,402, filed on Aug. 9, 2013.
(60) Provisional application No. 61/864,411, filed on Aug. 9, 2013.

(51) Int. Cl. G06Q 10/06

(52) U.S. Cl. CPC G06Q 10/06395
USPC 705/7.41

(57) ABSTRACT

Implementations described and claimed herein provide systems and methods for tracking attributes of an order for one or more products, such as telecommunication products or services. In one implementation, a record for an order for one or more products is generated. The record specifies sales exit criteria corresponding to one or more defects in the order. The record is stored in one or more databases. A notification for modifying the order is generated based on the sales exit criteria, and changes made to the order are tracked based on the sales exit criteria. The record is updated based on the tracked changes.

### CROSS-REFERENCE TO RELATED APPLICATIONS

The present application claims benefit under 35 U.S.C. §119(e) to U.S. Provisional Patent Application No. 61/864,402, entitled “Systems and Methods for Quality Order Tracking” and filed on Aug. 9, 2013, and to U.S. Provisional Patent Application No. 61/864,411, entitled “Systems and Methods for Order Attribute Tracking” and filed on Aug. 9, 2013, both of which are specifically incorporated by reference in their entirety herein.

### TECHNICAL FIELD

Aspects of the present disclosure relate to order quality tracking, collaboration, and management, among other functions, and more particularly to tracking changes to order attributes to prevent defects and eliminate rework.

### BACKGROUND

Industries delivering complex services, such as the telecommunications industry, generally require variability and flexibility in receiving, processing, and delivering an order. For example, a customer may provide needed information pertaining to the order at various times during order processing and/or aspects of the order many change prior to delivery. This often results in the introduction of defects in the order that are carried into the factory, which provisions the order for delivery. Generally, conventional methods fail to identify such defects until the order is submitted to the factory, necessitating a rework of the order. Reworking an order after it has been submitted to the factory often reduces revenue, customer satisfaction, efficiency, productivity, and quality.

It is with these observations in mind, among others, that various aspects of the present disclosure were conceived and developed.

### SUMMARY

Implementations described and claimed herein address the foregoing problems, among others, by providing systems and methods for tracking changes to order attributes to prevent defects in a provisioned order and to eliminate rework. In one implementation, a record for an order for one or more products is generated. The record specifies sales exit criteria corresponding to one or more defects in the order. The record is stored in one or more databases. A notification for modifying the order is generated based on the sales exit criteria, and changes made to the order are tracked based on the sales exit criteria. The record is updated based on the tracked changes.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example order management system, including a tracking system running on a computer server or other similar device coupled with a network, for tracking changes to order attributes to prevent defects in a provisioned order and to eliminate rework.

FIG. 2 illustrates example operations for tracking changes to order attributes.

FIG. 3 shows an example sales exit dashboard user interface.

FIG. 4 displays a new record user interface.

FIG. 5 shows a completing order user interface.

FIG. 6 shows a completed state user interface.

FIG. 7 is an example of a computing system that may implement various systems and methods discussed herein.

### DETAILED DESCRIPTION

Aspects of the present disclosure involve systems and methods for tracking changes to order attributes to prevent defects in a provisioned order (i.e., an order that has been provided or otherwise delivered to a customer) and to eliminate rework. In one particular aspect, an order for one or more products (e.g., telecommunication services or products) is received for review by a customer care manager or service delivery personnel, and it is determined whether the order is missing any information needed to provision the order. If no information is missing, the order is processed for provisioning to the customer. If information is missing, a record is created for the order specifying sales exit criteria, which identifies defects present in the order, including inadequate or missing critical attributes of the order needed to provision the one or more products. The record is submitted for review and correction to the order, and a notification of submission is sent to individuals listed on the order or other responsible parties. For example, where the record pertains to an order reviewed by a customer care manager, the record is submitted to the sales representative that took the order, and where the record pertains to an order reviewed by service delivery, the record is submitted to a quality circle. The order is corrected based on the record and submitted to the factory for provisioning the one or more products.

Generally, the systems and methods described herein create, manage, and track records detailing changes made to orders to remedy attributes of the order before the order exits sales for processing and delivery. The systems and methods increase collaboration for identifying, tracking, and remedying defects in an order prior to the order being submitted to the factory for provisioning. In some aspects, a nature of the defects and/or the causes underlying the defects are logged and notifications to sales are triggered, thereby providing records of corrections made, high bars, common order defects, and other trend data. The systems and methods described herein deliver products correctly by improving order quality early in the process and reducing rework late in the process. As such, the systems and methods described herein, improve productivity and process efficiency, accelerate revenue, increase order quality and customer satisfaction, and provide standardization in tracking and managing orders.

The various systems and methods disclosed herein provide for tracking changes to order attributes to prevent defects in provisioned orders and to eliminate rework, as well as for collecting and managing data to determine trends for common order defects. The example implementations discussed herein reference the telecommunications industry. However, it will be appreciated by those skilled in the art that the presently disclosed technology is applicable to other industries and data involving the sale and delivery of complex services, such as the shipping industry, financial industry, and the like.

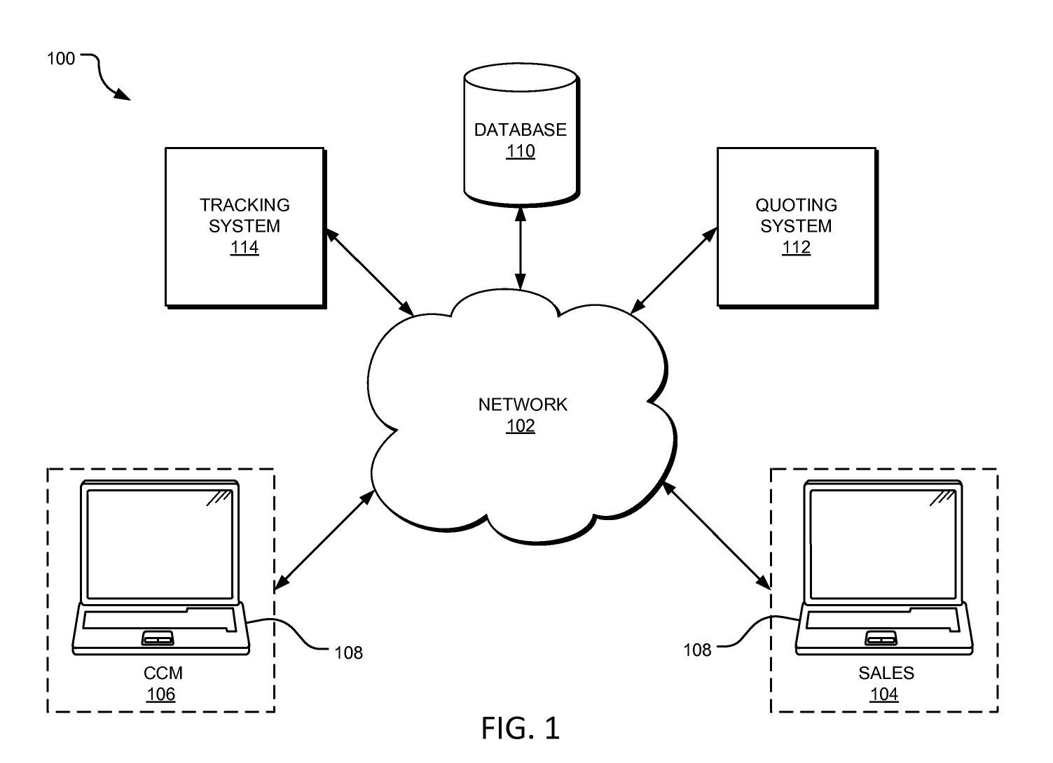

Referring to FIG. 1, an example order management system 100 for tracking changes to order attributes is shown. In one implementation, changes to order attributes are recorded and tracked via a network 102 (e.g., the Internet).

Once an order for one or more products (e.g., one or more telecommunication services) is received, a user associated with the company taking the order accesses and interacts with the order management system 100 using a user device 108 communicatively connected to the network 102. The user may be any authorized user, including, without limitation, a sales representative 104, a customer care manager (CCM) 106, service delivery personnel, quality circle personnel, or the like. The user device 108 is generally any form of computing device capable of interacting with the network 102, such as a personal computer, terminal, workstation, portable computer, mobile device, tablet, a multimedia console, etc. The network 102 is used by one or more computing or data storage devices (e.g., one or more databases 110) and other computing devices for implementing a quoting system 112, a tracking system 114, and other services, applications, and/or modules in the order management system 100.

In one implementation, the network 102 includes at least one server hosting a website or an application that the user may visit to access the quoting system 112 and/or the tracking system 114. The at least one server may be a single server, a plurality of servers with each such server being a physical server or a virtual machine, or a collection of both physical servers and virtual machines. In another implementation, a cloud hosts one or more components of the order management system 100. The user devices 108, the server, and other resources connected to the network 102 may access one or more other servers to access to one or more websites, applications, web services interfaces, storage devices, computing devices, and the like that are used to manage orders. The server may also host a search engine that the order management system 100 uses for accessing, searching for, and modifying quote data, order data, product data, customer data, and/or other information.

As can be understood from FIG. 1, in one implementation, the sales representative 104 utilizes the quoting system 112 to input order attributes to receive a quote for a customer for one or more products. The products may include various telecommunications services or products, for example phone, internet, cable, or the like. The quoting system 112 may be any system, tool, or application capable of generating a quote for a particular customer for various product types. For example, the quoting system 112 may include various quoting tools, such as IFO, Siebel, Pipeline, and/or the like. Once the customer accepts the quote through a signed customer proposal, an order for the one or more products is submitted by the sales representative 104.

Because of the complex nature of telecommunications services and to increase customer satisfaction by quickly and efficiently moving the order process forward to provision the products, the sales representative 104 often obtains a quote with missing or insufficient information that will be later needed to provision the products. Stated differently, the sales representative 104 obtains sufficient data to generate a quote permitting the customer to understand the costs that would be involved for receiving the products, but there may be defects in the order, such as insufficient data to provision the product. For example, critical order attributes in the order may be missing or inadequate.

Generally, orders are processed for provisioning by a factory. For example, in the telecommunications industry, the factory may install and activate telecommunications products or services based on various details included in an order, such as technical product data, customer information, infrastructure data corresponding to the telecommunication provider offering the product or service, and the like. To prevent any defects in the order from flowing into the factory, a user, such as the CCM 106, sales delivery personnel, or other quality control personnel, utilizes the tracking system 114 to correct critical order attributes for provisioning the products before the order exits from the sales process stage. In one implementation, the tracking system 114 assists in provisioning products correctly the first time by improving order quality early in the process and reducing rework late in the process.

To accomplish this, in one implementation, the tracking system 114 automatically analyzes the order to identify and/or remedy defects. In another implementation, the tracking system 114 provides the order to a user for review. For example, the CCM 106 may receive an order to review after the sale representative 104 takes the order. The CCM 106 determines if any critical attributes are missing or inadequate in the order or if any other defects are present. For example, defects may include, missing or inadequate critical attributes relating to the quote, customer information, basic order information, and/or the like. If no defects are present in the order, the CCM 106 releases the order, which submits the order to service delivery for review, other personnel for further processing, or the factory for provisioning.

If the CCM 106 identifies defects in the order, the CCM utilizes the tracking system 114 to generate a new record for the order specifying sales exit criteria, which corresponds to information that needs addressing before the order may be released for provisioning the product. Stated differently, the sales exit criteria may identify one or more defects in information contained in the order that needs to be remedied to provision the products for the customer correctly. The record may be stored in the one or more databases 110.

In one implementation, the tracking system 114 submits the record for modifying the order based on the sales exit criteria. Once the record is submitted, the tracking system 114 generates a notification to one or more responsible parties for remedying the defects. For example, the record submitted by the CCM 106 may be submitted to the sales representative 104 that took the order for correction. The notification may be an email, visual and/or audio alert, or other electronic notification providing the record to the one or more responsible parties, for example by attaching the record, providing a link to the record, providing instructions for accessing the record, or the like.

The tracking system 114 tracks the progress of the record, including tracking any changes made to the order and any communications among the parties included on the notifications corresponding to the order. Updates to the record based on the tracked changes may be stored in the one or more databases 110. Once the defects in the order are corrected, the CCM 106 enters a closure code identifying the nature of the sales exit criteria (e.g., a system defect, a process defect, or training issue) to close the record, which triggers a notification to the responsible parties. Once the record is completed, the tracking system 114 releases the order. The completed record may be stored in the one or more databases 110.

In some implementations, after the CCM 106 completes the record, sales delivery receives the order for review. Sales delivery determines if any critical attributes are missing or inadequate in the order or if any other defects are present. If no defects are present in the order, sales delivery completes the order, which releases the order from sales and submits the order to the factory for provisioning the products or to other personnel for further processing.

If sales delivery identifies defects in the order, sales delivery utilizes the tracking system 114 to create a new record specifying sales criteria. In one implementation, the sales criteria includes a stage of the order for provisioning the products. For example, the record may include an option selected to indicate whether the record is in the sales delivery stage or the customer care stage. The tracking system 114 submits the record to the quality circle for review. As discussed above, as the quality circle reviews the record and order, the tracking system 114 provides notifications to responsible parties and tracks any changes to or communications concerning the record created by sales delivery. Once the defects in the order are remedied, the record is completed, and the tracking system 114 releases the order for provisioning the products.

In one implementation, to complete a record, a closure code identifying the nature of the defects and/or other aspects of the sales exit criteria is entered. The tracking system 114 may generate analytics based on the closure codes of the various records stored in the one or more databases 110. In one implementation, the analytics identify common order defect, which may be presented in the form of trends, high bars, or the like to identify and address recurring defects.

The tracking system 114 provides uniformity in creating and maintaining records of corrections made to and communications concerning orders, thereby efficiently managing the sales process and collecting data for auditing and to identify and address recurring defects. This information may be used to optimize the sales process, improve order quality early in the process, and reduce rework late in the process, thereby saving money and improving customer satisfaction. The tracking system 114 mandates collaboration between sales 104, CCM 106, sales engineers, service delivery personnel, and the like to actively identify defects and technical attributes without which the orders cannot be processed for provisioning to customer. In one implementation, the tracking system 114 includes an email engine built configured to trigger notifications to one or more responsible parties, such as a fix agent once a defect is identified. For example, a Billing Account Number (BAN) may be missing or incorrect and/or a customer signed proposal may be missing. In one implementation, the tracking system 114 ensures compliance with internal auditing on any price changes. As such, the order management system 100 provides a preventative approach in improving sale order quality, delivering orders correctly the first time, holding stakeholders accountable, and reducing rework, thereby accelerating the order and delivery process.

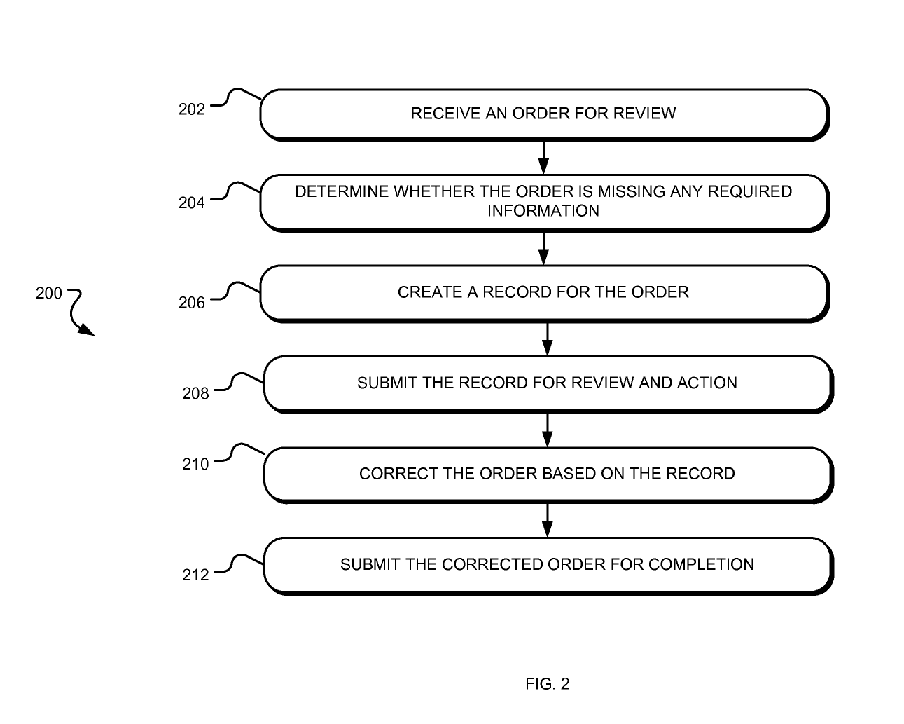

For a detailed description of example operations 200 for tracking changes to order attributes, reference is made to FIG. 2. An operation 202 receives an order for one or more products. In one implementation, the order is received by a CCM. In another implementation, the order is received by sales delivery. In still another implementation, the order is received at a computing device for automatic analysis. An operation 204 determines whether the order is missing any required information, such as critical attributes for provisioning the one or more products, or whether the order has any other defects, including other inadequate or missing information needed for provisioning the one or more products.

If the determining operation 204 identifies defects in the order, an operation 206 creates a record for the order specifying sales criteria for releasing the order. In one implementation, the sales criteria corresponds to information for provisioning the one or more products. For example, the sales criteria may identify the defects, any action items to correct the defects, and/or a stage of the record (e.g., in the CCM stage or sales delivery stage). An operation 208 submits the record for review and action for modifying the order based on the sales exit criteria. In one implementation, where the record is in the CCM stage, the operation 208 submits the record to a sales representative that took the order, and where the record is in the sales delivery stage, the operation 208 submits the record to a quality circle. The operation 208 may generate notifications to one or more responsible parties upon submission of the record.

An operation 210 corrects the order based on the record. During the correction process, the operation 210 tracks any changes to the record and any communications concerning the record. Once the defects are addressed, the operation 210 completes the record, which is stored in one or more databases. In one implementation, to complete the record, the operation 210 submits a closure code indicating the nature of the sales criteria (e.g., the defects) associated with the record. After the record is closed, an operation 212 submits the corrected order for completion. In one implementation, the operation 212 submits the order for further review and processing, for example, to sales delivery for review. In another implementation, the operation 212 releases the order from sales and submits the order to the factory for provisioning the one or more products.

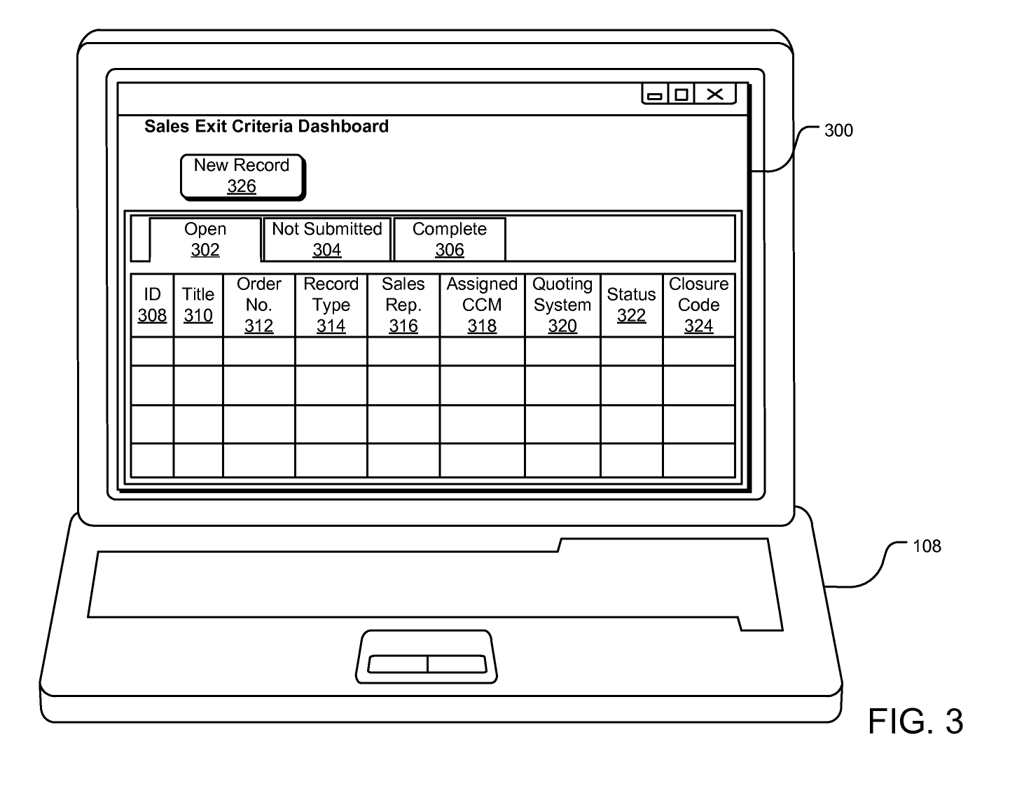

FIGS. 3-5 show example user interfaces generated by the tracking system 112 and displayed in a browser window of the user device 108 through which access to and interactions with quotes, orders, records, analytics, and other data is provided. It will be appreciated by those skilled in the art that such depictions are exemplary only and not intended to be limiting.

In one implementation, a user, such as the sales representative 104, the CCM 106, sales delivery personnel, quality circle personnel, or other responsible parties, accesses the tracking system 112 via a link in an email, alert, or other notification. In another implementation, the user accesses the tracking system 112 directly by logging into an account.

FIG. 3 shows an example user interface presenting a sales exit dashboard 300. In the implementation shown in FIG. 3, the dashboard 300 organizes records for tracking changes to order attributes in which a user is involved.

As can be understood from FIG. 3, in one implementation, the dashboard 300 organizes the records according to their status. For example, the dashboard 300 may include an open tab 302 for displaying open records (i.e., submitted records that are not completed), a not submitted tab 304 for displaying records that have been created but not submitted, and a complete tab 306 for displaying completed records. The tabs 302, 304, and 306 allow the user to change the view of the dashboard 300 to show records in different statuses.

In one implementation, the dashboard 300 details information regarding the records, including, without limitation, an identification number (ID) 308, a title 310, an order number 312, a record type 314, a sales representative 316, an assigned customer care manager (CCM) 318, a quoting system 320, a status 322, and a closure code 314. The ID 308 is an assigned number through which the record may be tracked and may include a link for selection to open the record for viewing and/or editing. The record type 314 identifies the stage of the record (e.g., in the CCM stage, the sales delivery stage, or the like). The sales representative 316 details the contact information (e.g., email), user name, or name of the account director associated with the record or the sales representative that took the order. The assigned CCM 318 shows the contact information (e.g., email), user name, or name of the CCM assigned to the order (e.g., the CCM that created the record for the order). The quoting system 320 details the quoting system that was used in generating the quote (e.g., Siebel, IFO, Pipeline, etc.). The status 322 indicates the status of the record (e.g., open, complete, not submitted). In one implementation, the status 322 is not displayed where one of the tabs 302, 304, or 306 is selected because all the records displayed with the selection of one of the tabs 302, 304, or 306 already shows records with the selected status. The closure code 324 identifies the nature of the sales exit criteria addressed in the record (e.g., system defect, process defect, training defect, etc.), where the record has been completed. As such, in one implementation, the closure code 324 is not displayed where the open tab 302 or the not submitted tab 304 is selected.

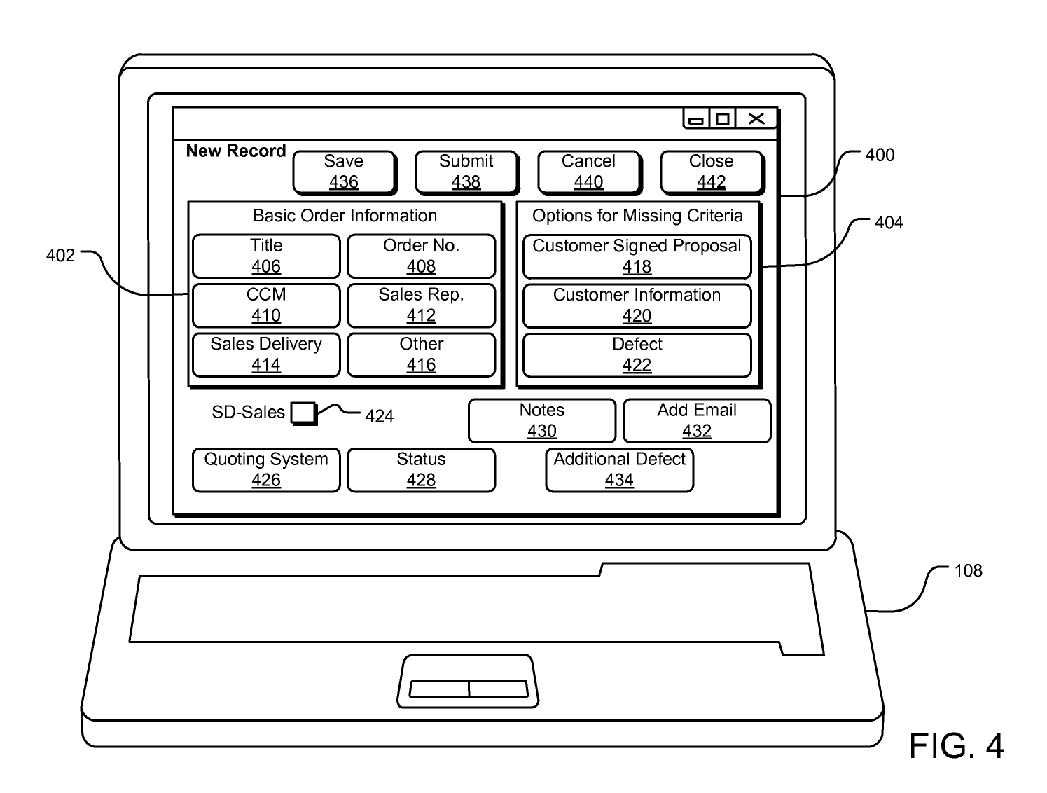

In one implementation, the dashboard 300 includes a new record button 326, which may be selected to add a new record for an order having sales exit criteria, such as critical attributes needed for the order to proceed or other defects. For a detailed description of an example new record user interface 400, reference is made to FIG. 4.

As can be understood from FIG. 4, in one implementation, the new record user interface 400 includes fields to enter basic order information 402 and options for missing criteria 404. The basic order information 402 includes information about the order, including, without limitation, a title 406, an order number 408, a CCM 410, a sales representative 412, a sales delivery representative 414, and any other responsible parties 416. The fields 410-416 are for entering contact information (e.g., email), a user name, and/or name of the respective personnel assigned to the order.

The options for missing criteria 404 provide fields for inputting sales exit criteria, such as details regarding defects present in the order. In one implementation, the options for missing criteria 404 includes, without limitation, customer signed proposal information 418, customer information 420, and defect information 422. The customer signed proposal information 418 involves missing or inadequate information relating to the quote, such as a signed customer proposal not being attached, the customer proposal missing the customer signature, the signed customer proposal not matching the order created, and the like. The customer information 420 involves missing or inadequate information relating to the customer, such as the customer primary contact name, the customer contact email or phone number, and the like. The defect information 422 specifies the nature of other defects, which may be selected, for example, from a drop down menu, or manually entered.

In one implementation, the new records user interface 400 includes an option 424 for identifying the stage of the record. For example, the option 424 may be a sales delivery (SD)-sales option to indicate that the record was created by sales delivery rather than a CCM. Further, the new records user interface 400 may include additional fields, such as a quoting system 426, status 428, notes 430, and/or additional options, such as an add email option 432 and an add additional defect option 434. The add email option 432 permits the user to add the email addresses of any parties for inclusion on notifications regarding the record and order, and the add additional defect option 434 permits the user to add a custom defect. In one implementation, selecting the quoting system 426, status 428, notes 430, add email option 432, or add additional defect option 434 will open a new window. Further, in one implementation, selecting the CCM 410, the sales representative 412, or the sales delivery 416 will open a new window where the user may search for an email to include in those fields.

The new record user interface 400 further includes a save button 436, a submit button 438, a cancel button 440, and a close button 442, permitting the user to submit the record, save and close a record for later population and submission, or cancel. In one implementation, submitting the record generates notifications to the responsible parties involved with the record, such as those whose email addresses were added with the add email 432, the CCM 410, the sales representative 412, and the sales delivery representative 414.

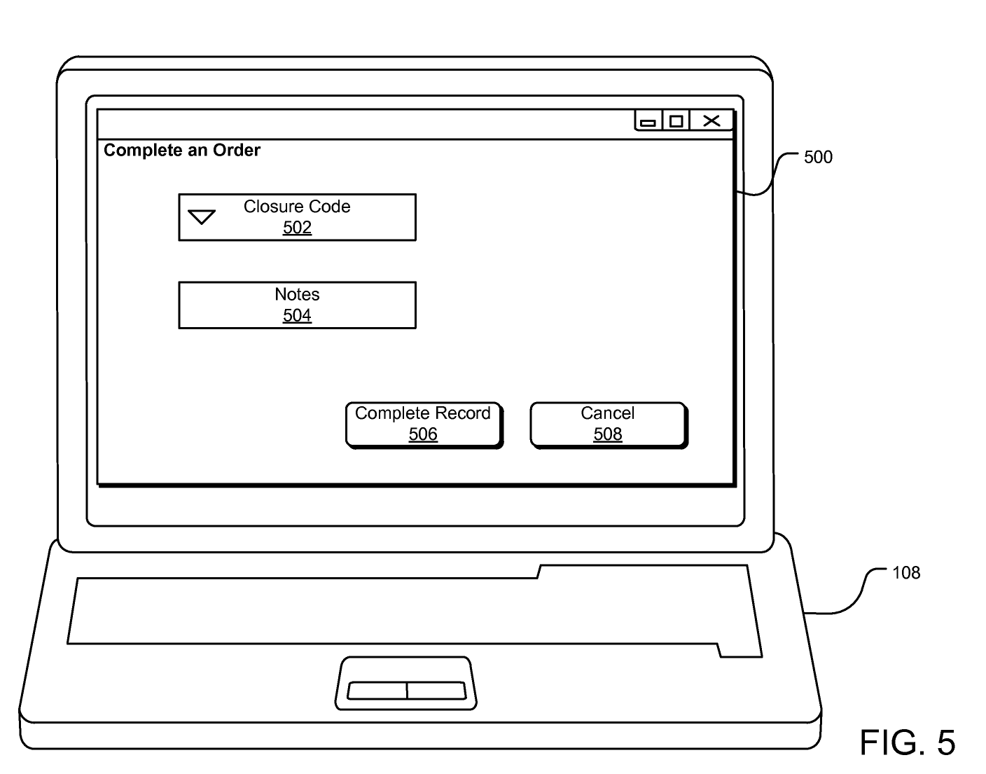

Turning to FIG. 5, a complete order user interface 500 is shown. In one implementation, the complete order user interface 500 includes fields for entering information needed to complete the record. In one implementation, the fields include a closure code 502 and notes 504, which are optional. The closure code 502 indicates the nature of the issue underlying the sales exit criteria for the order (e.g., a nature of defects in the order) to assist in optimizing the sales process and generating trend and high bar analyses. Once the information is input into the field(s), a complete record button 506 may be selected to close the record. In one implementation, closing the record generates notifications to the responsible parties involved with the record. A cancel button 508 allows the user to exit from the complete order user interface 500.

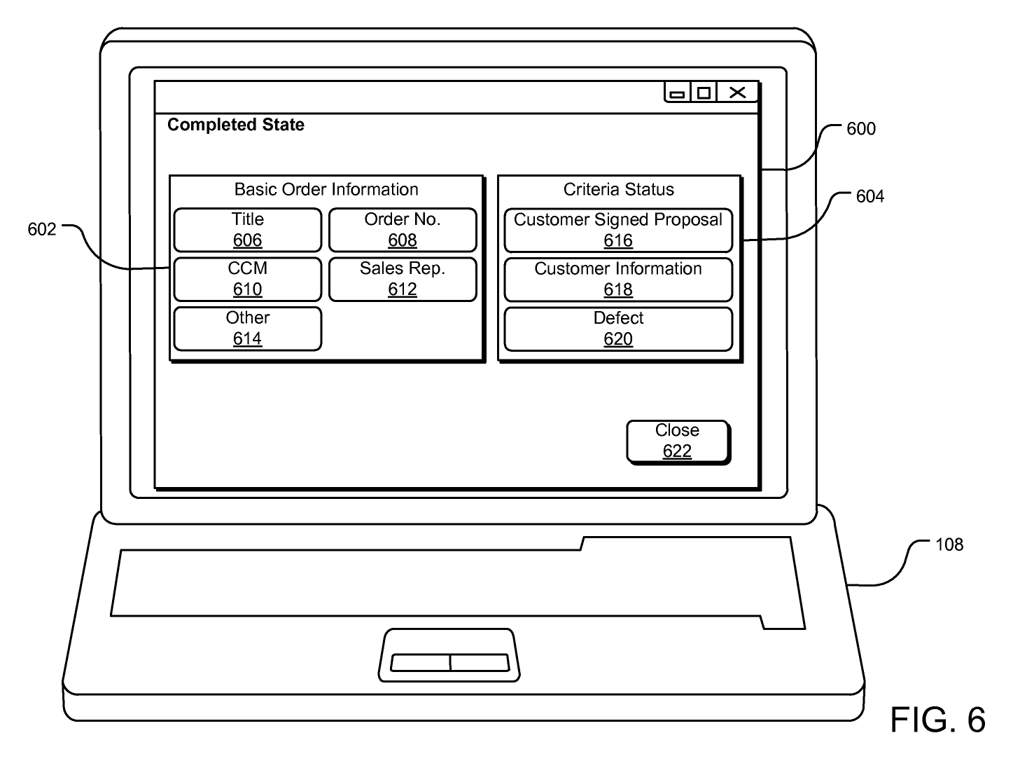

FIG. 6 shows an example completed state user interface 600, which displays updated sales criteria for a record. In one implementation, basic order information 602 and criteria status 604 are presented. The basic order information 602 includes information about the order, including, without limitation, a title 606, an order number 608, a CCM 610, a sales representative 612, and any other responsible parties 614. The fields 610-614 present contact information (e.g., email), a user name, and/or name of the respective personnel assigned to the order.

In one implementation, the criteria status 604 presents a status of an action items for sales exit criteria. For example, the criteria status 604 includes, without limitation, customer signed proposal information status 616, customer information status 618, and defect information status 620. The customer signed proposal information status 616 provides a status (e.g., open, closed, etc.) of remedying missing or inadequate information relating to the quote, such as a signed customer proposal not being attached, the customer proposal missing the customer signature, the signed customer proposal not matching the order created, and the like. The customer information status 618 involves a status (e.g., open, closed, etc.) of remedying missing or inadequate information relating to the customer, such as the customer primary contact name, the customer contact email or phone number, and the like. The defect information status 620 specifies a status (e.g., open, closed, etc.) of remedying any custom defects. In one implementation, the criteria status 604 is updated as the sales exit criteria is addressed. Once all the sales exit criteria are addressed, the record is completed, which is reflected in the criteria status 604. A close button 622 may be used to exit the completed state user interface 600.

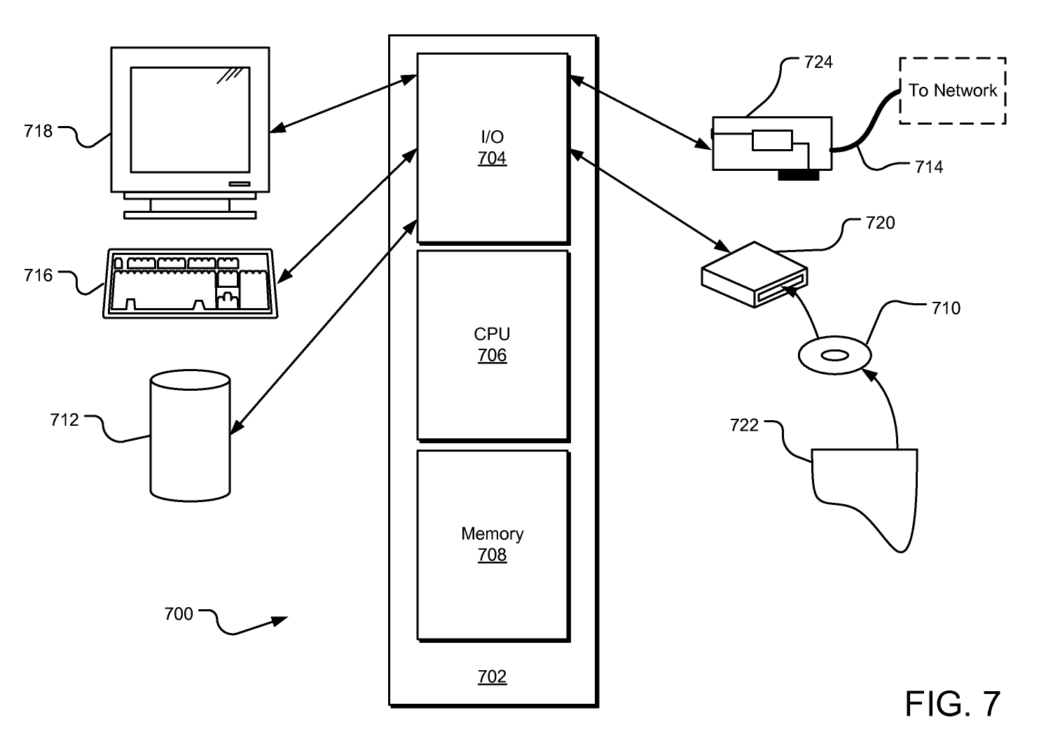

Referring to FIG. 7, a detailed description of an example computing system 700 having one or more computing devices that may implement various systems and methods discussed herein is provided. The computing system 700 may be applicable to the user device 108, the server, or other computing devices. It will be appreciated that specific implementations of these devices may be of differing possible specific computing architectures not all of which are specifically discussed herein but will be understood by those of ordinary skill in the art.

The computing system 700 may be a general purpose computer system capable of executing a computer program product to execute a computer process. Data and program files may be input to the computer system 700, which reads the files and executes the programs therein. Some of the elements of a general purpose computer system 700 are shown in FIG. 7 wherein a processor 702 is shown having an input/output (I/O) section 704, a Central Processing Unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a distributed computer, or any other type of computer, such as one or more external computers made available via a cloud computing architecture. The presently described technology is optionally implemented in software devices loaded in memory 708, stored on a configured DVD/CD-ROM 710 or storage unit 712, and/or communicated via a wired or wireless network link 714, thereby transforming the computer system 700 in FIG. 7 to a special purpose machine for implementing the described operations.

The I/O section 704 is connected to one or more user-interface devices (e.g., a keyboard 716 and a display unit 718), a disc storage unit 712, and a disc drive unit 720. Generally, the disc drive unit 720 is a DVD/CD-ROM drive unit capable of reading the DVD/CD-ROM medium 710, which typically contains programs and data 722. Computer program products containing mechanisms to effectuate the systems and methods in accordance with the presently described technology may reside in the memory section 704, on a disc storage unit 712, on the DVD/CD-ROM medium 710 of the computer system 700, or on external storage devices made available via a cloud computing architecture with such computer program products, including one or more database management products, web server products, application server products, and/or other additional software components. Alternatively, a disc drive unit 720 may be replaced or supplemented by an optical drive unit, a flash drive unit, magnetic drive unit, or other storage medium drive unit. Similarly, the disc drive unit 720 may be replaced or supplemented with random access memory (RAM), magnetic memory, optical memory, and/or various other possible forms of semiconductor based memories commonly found in smart phones and tablets.

The network adapter 724 is capable of connecting the computer system 700 to a network via the network link 714, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as mobile phones, tablets, multimedia consoles, gaming consoles, set top boxes, etc.

When used in a LAN-networking environment, the computer system 700 is connected (by wired connection or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are examples of communications devices for and other means of establishing a communications link between the computers may be used.

In an example implementation, order and quote data, critical attributes, tracking data, trend and high bar data, a plurality of internal and external databases (e.g., the one or more databases 110), source databases, and/or data cached on cloud servers are stored as the memory 708 or other storage systems, such as the disk storage unit 712 or the DVD/CD-ROM medium 710, and/or other external storage devices made available and accessible via a cloud computing architecture. Quote generation and tracking software and other modules and services may be embodied by instructions stored on such storage systems and executed by the processor 702.

Some or all of the operations described herein may be performed by the processor 702. Further, local computing systems, remote data sources and/or services, and other associated logic represent firmware, hardware, and/or software configured to control operations of the order management system 100. Such services may be implemented using a general purpose computer and specialized software (such as a server executing service software), a special purpose computing system and specialized software (such as a mobile device or network appliance executing service software), or other computing configurations. In addition, one or more functionalities of the order management system 100 disclosed herein may be generated by the processor 702 and a user may interact with a Graphical User Interface (GUI) using one or more user-interface devices (e.g., the keyboard 716, the display unit 718, and the user devices 108) with some of the data in use directly coming from online sources and data stores. The system set forth in FIG. 7 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions. The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various implementations, it will be understood that these implementations are illustrative and that the scope of the disclosure is not limited to them. Many variations, modifications, additions, and improvements are possible. More generally, aspects of the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A method for managing changes to an order for one or more products for a customer comprising:
generating a record for the order using at least one computing device, the record specifying sales exit criteria for releasing the order, the sales exit criteria corresponding to information for provisioning the one or more products;
storing the record in one or more databases using the at least one computing device;
submitting the record for modifying the order based on the sales exit criteria using the at least one computing device; and
storing a completed record in the one or more databases using the at least one computing device, the completed record including a closure code identifying a nature of the sales exit criteria.

2. The method of claim 1, wherein the sales exit criteria identifies one or more defects in the information for provisioning the one or more products.

3. The method of claim 2, wherein the one or more defects includes one or more of: at least a portion of the information for provisioning the one or more products is missing; and at least a portion of the information is inadequate for provisioning the one or more products.

4. The method of claim 2, wherein the one or more defects involve a customer proposal for provisioning the one or more products.

5. The method of claim 4, wherein the one or more defects includes at least one: the customer proposal is missing; the customer proposal is missing a signature of the customer; or the customer proposal fails to match the order.

6. The method of claim 2, wherein the one or more defects involve customer information for provisioning the one or more products.

7. The method of claim 1, further comprising:
generating analytics based on the closure code using the at least one computing device, the analytics identifying one or more common order defects.

8. The method of claim 1, further comprising:
generating a notification to one or more responsible parties upon submission of the record.

9. The method of claim 8, wherein the notification is an email.

10. The method of claim 1, wherein the sales exit criteria includes a stage of the order for provisioning the one or more products.

11. The method of claim 1, wherein the one or more products include telecommunication products or services.

12. One or more non-transitory tangible computer-readable storage media storing computer-executable instructions for performing a computer process on a computing system, the computer process comprising:
generating a record for an order for one or more products, the record specifying sales exit criteria corresponding to one or more defects in the order;
storing the record in one or more databases;
generating a notification for modifying the order based on the sales exit criteria;
tracking changes made to the order based on the sales exit criteria; and
updating the record based on the tracked changes.

13. The one or more non-transitory tangible computer-readable storage media of claim 12, further comprising:
releasing the order for provisioning the one or more products once the one or more defects are remedied.

14. The one or more non-transitory tangible computer-readable storage media of claim 13, further comprising:
storing a completed record in the one or more databases upon release of the order, the completed record including a closure code identifying a nature of the one or more defects.

15. The one or more non-transitory tangible computer-readable storage media of claim 14, further comprising:
generating analytics based on the closure code, the analytics identifying one or more common order defects.

16. The one or more non-transitory tangible computer-readable storage media of claim 12, wherein the notification is an email.

17. A system for managing changes to an order for one or more products for a customer comprising:
one or more databases configured to store an order for one or more products; and
at least one server configured to generate a record for the order specifying sales exit criteria corresponding to one or more defects in the order and configured to track any changes made to the order based on the sales exit criteria using the record.

18. The system of claim 17, wherein the at least one server is further configured to release the order for provisioning the one or more products once the record indicates that the one or more defects are remedied.

19. The system of claim 18, wherein the at least one server is further configured to storing a completed record in the one or more databases upon release of the order, the completed record including a closure code identifying a nature of the one or more defects.

20. The system of claim 17, wherein the one or more defects includes one or more of: at least a portion of information in the order for provisioning the one or more products is missing; and at least a portion of information in the order is inadequate for provisioning the one or more products.
